(19) United States
(12) Patent Application Publication
(10) Pub. No.: US 2020/0387551 A1
(43) Pub. Date: Dec. 10, 2020

(54) EXAMPLE-BASED ONTOLOGY TRAINING FOR NATURAL LANGUAGE QUERY PROCESSING

(71) Applicant: Microsoft Technology Licensing, LLC, Redmond, WA (US)

(72) Inventors: Christopher A. Hays, Monroe, WA (US); Eeshan M. Shah, Seattle, WA (US); Aaron Meyers, Redmond, WA (US); Tu H. Phan, Redmond, WA (US)

(73) Assignee: Microsoft Technology Licensing, LLC, Redmond, WA (US)

(21) Appl. No.: 16/435,072

(22) Filed: Jun. 7, 2019

(51) Int. Cl. G06F 16/9032; G06F 17/27

(52) U.S. Cl. CPC G06F 16/90332; G06F 17/2725; G06F 17/2735

(57) ABSTRACT

In some examples, example-based ontology training for natural language query processing may include identifying, based on an analysis of a query by using an ontology, a term in the query that includes an unknown meaning. The query may be in a natural language format. Based on a context of the query, a proposed definition of the term may be inferred. Based on the proposed definition of the term, a request may be generated to provide a definition of the term, or to modify the proposed definition of the term. A reply to the request may be received. The reply may be in the natural language format. The reply may be analyzed to update the proposed definition of the term. The ontology may be modified to include the updated definition of the term. Based on the modified ontology, a response to the query may be generated.

### BACKGROUND

A query system, such as a natural language query system, may be used to provide a response to a query based on an analysis of data, such as structured data. For example, a user may present a query in a natural language format that is native to the user and receive a response, without the need for the user to convert the query into a language that is specific to a computer.

### BRIEF DESCRIPTION OF DRAWINGS

Features of the present disclosure are illustrated by way of example and not limited in the following figure(s), in which like numerals indicate like elements, in which:

FIG. 1 illustrates a layout of an example-based ontology training for natural language query processing apparatus in accordance with an embodiment of the present disclosure;

FIGS. 2-4 illustrate graphical user interface (GUI) displays to illustrate operation of the example-based ontology training for natural language query processing apparatus of FIG. 1 in accordance with an embodiment of the present disclosure;

FIG. 5 illustrates an example block diagram for example-based ontology training for natural language query processing in accordance with an embodiment of the present disclosure;

FIG. 6 illustrates a flowchart of an example method for example-based ontology training for natural language query processing in accordance with an embodiment of the present disclosure; and

FIG. 7 illustrates a further example block diagram for example-based ontology training for natural language query processing in accordance with another embodiment of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Example-based ontology training for natural language query processing apparatuses, methods for example-based ontology training for natural language query processing, and non-transitory computer readable media having stored thereon machine readable instructions to provide example-based ontology training for natural language query processing are disclosed herein. In order to generate a response to a query, the apparatuses, methods, and non-transitory computer readable media disclosed herein provide for identification of a term from a query, where the term includes an unknown meaning. Based on a context of the query, a proposed definition may be inferred for the term. A user, such as a domain expert, may receive guidance via prompts as to what type of a definition is expected for the term. For example, a request may be generated for the user to provide a definition for the term, or to modify the proposed definition for the term. A reply that is received for the request may be used to update the proposed definition for the term, and to modify an ontology to include the updated definition. The modified ontology may be used to generate the response to the query.

With respect to query systems, such as natural language query systems, examples of techniques that may be used to implement such query systems may include statistical artificial intelligence based query systems, and symbolic artificial intelligence based query systems.

A statistical artificial intelligence based query system may implement techniques such as hidden Markov models, and deep neural networks. Such a system may be trained by providing a relatively large number of annotated pairs of a sample natural language question with a corresponding structured computer query. The system may then generalize from this training data to translate unique new queries into a structured computer query.

A symbolic artificial intelligence based query system may utilize a set of rules and heuristics to interpret a query in the context of encoded factual knowledge about a data source. According to examples disclosed herein, a rule may indicate that adjectives modify nouns, and other such relationships. According to examples disclosed herein, heuristics may indicate that more distantly related objects are less likely to be what a user intended, and other such aspects. According to examples disclosed herein, factual knowledge may include knowledge of customers that return products on a final return date, and other such facts. The target data source may include any type of data source such as a relational database, and other such data sources.

With respect to the symbolic artificial intelligence based query system, a user may specify a query such as “Which customers bought cheese?”. The symbolic artificial intelligence based query system may include innate knowledge about the structure of English (e.g., including that the word “which” indicates the following word identifies a topic of interest). The symbolic artificial intelligence based query system may also include a knowledge about a particular target structured data source (e.g., the word “customer” refers to rows in a CUSTOMER table of the data source). The word “cheese” may appear as a value in a name column of a PRODUCT table of the data source. Further, “customers buy products” may be included as a relationship embodied in an ORDER table of the data source. Based on these facts with respect to the data source, as well as the system's knowledge of language structure and query structure, a structured computer query may be constructed as “Select CUSTOMER From ORDER Where PRODUCT.Name=‘cheese’”.

An aspect of a symbolic artificial intelligence based query system may include gathering of relevant knowledge about the data source. Without this knowledge, capabilities of the symbolic artificial intelligence based query system may be limited to terms that include known meanings. In this regard, while some general terms may be guessed (e.g., “customer” may refer to roles in a CLIENT table, and “customers buy products” may be a likely conclusion if the data source contains customers and products), domain specific vocabulary and relationships may be common, and may need to be explicitly taught to the symbolic artificial intelligence based query system. For example, in order to interpret the query “how many red gauge sensors have registered warnings against B74”, the system may need to know that red gauge sensors have Type=R, and that gauges register warnings against control blocks (in addition to which objects in the data source represent sensors, warnings, and control blocks).

Thus, with respect to symbolic artificial intelligence based query systems, it is technically challenging to accrue knowledge, such as domain specific knowledge, that may be needed for symbolic natural language query processing. In this regard, one technique of addressing these technical challenges may include implementing a data entry method by which a domain expert may provide facts directly to the symbolic artificial intelligence based query system. For example, a user interface may be provided to allow a user, such as a domain expert, to bind “synonyms” to tables and columns in a data source, and another user interface may be provided to allow the user to define “phrasings” that describe how people talk about the relationships between objects in the data store (e.g., “employees provide customers refunds for products”). Another technique of addressing the aforementioned technical challenges may include application of a broad spectrum ontology (or one or more general-purpose domain specific ontologies) to a data source with the goal of determining the best possible matches for each object and/or relationship. This technique (e.g., application of a broad spectrum ontology) of addressing the aforementioned technical challenges may include further technical challenges with respect to accuracy (e.g., due to non-applicable terms being applied), and recall (e.g., due to a high frequency of unique domain specific terms that may not be present in shared ontologies). The apparatuses, methods, and non-transitory computer readable media disclosed herein address at least the aforementioned technical challenges by implementing example based training of an ontology for responding to a natural language query.

With respect to implementation of example based training by the apparatuses, methods, and non-transitory computer readable media disclosed herein, generally, a query that is entered by a user may be analyzed for terms that are not understood (e.g., include an unknown meaning). Alternatively or additionally, queries that are not correctly understood may represent a starting point for training. In this regard, another user, such as a domain expert, may be prompted (e.g., by a request) to provide definitions for terms in the query (or queries), where such terms may not be recognized or include an unknown meaning. The request may guide the user (e.g., domain expert) regarding the type of definition that is expected. In some examples, a request may include one or more proposed definitions of the term. A reply that is received for the request may be used to update the proposed definition for the term, and to modify an ontology to include the updated definition. The modified ontology may be used to generate the response to the query.

The aforementioned operations of the apparatuses, methods, and non-transitory computer readable media disclosed herein may be implemented by performing utterance selection, unknown term inference, definition editing, and reinterpretation.

With respect to utterance selection, a query may be received upon entry by a user. Alternatively or additionally, an author of a data source may select a target query for analysis. Alternatively or additionally, queries may be selected from a log of end user queries. For example, queries that include most frequently used unknown terms (e.g., terms that include unknown meanings) may be selected. From the selected queries, queries that include a fewest number of unknown terms, and a shortest query length may be identified. With respect to selection of the queries that include a fewest number of unknown terms, and a shortest query length, an example may include a query that indicates “how many products were discontinued” as opposed to a query that indicates “which of the customers lived in the Eastern time zone and bought products that were discontinued”. In this example, both queries may include “discontinued” as a term with an unknown meaning, but the second query may also include “customers” and “zone” as terms with an unknown meaning. Thus the query “how many products were discontinued” may be selected based on the determination that it includes the fewest number of unknown terms, and the shortest query length. A user, such as a domain expert, may be guided using such a query to facilitate comprehension by the user, and training of the ontology as disclosed herein. With respect to selection of the queries that include most frequently used unknown terms, an example may include a set of queries that indicate “how many products were discontinued”, and a query that indicates “how many products were embargoed”. In this example, the queries may include “discontinued” and “embargoed” as terms with an unknown meaning. However, the query “how many products were discontinued” may be selected based on the determination that it belongs to a set of queries that include the most frequently used unknown terms.

With respect to unknown term inference, placeholder meanings may be assigned to unknown terms in a query. Further, the query may be interpreted using the placeholder meanings. A placeholder meaning may be defined as a “tentative” meaning of a term that includes an unknown meaning. For example, for the query “how many products were discontinued”, a tentative meaning for the term “discontinued” may be an adjective (e.g., as opposed to “discontinued” being a verb, a noun, etc.). An interpretation of the query using this placeholder meaning may be that “discontinued” modifies “products”. As disclosed herein, a definition of such a term may be specified as “discontinued products have status=X”, as opposed to a definition that indicates “discontinued means:”.

With respect to unknown term inference, proposed definitions may be inferred for the unknown term from the placeholder meanings, and a context of the query. For example, if a query indicates “which customers returned more than three products last week”, and a meaning of the term “returned” is unknown, based on the context of the query, as well as any placeholder meaning assigned to the unknown term, it may be determined that “return” is a verb, and that the definition of return is “customers return products” based on the context of the query.

According to another example, for a query that indicates “which customer bought the tallest product”, where the term “tallest” may include an unknown meaning, a placeholder meaning assigned to the term “tallest” may be a superlative adjective. An interpretation of the query using this placeholder meaning may be that “tallest” modifies “product”. Further, a proposed definition of this term based on the context of the query and the placeholder meaning may be determined based on a determination that the term “tallest” likely includes a number associated therewith (e.g., width, height, etc.). Thus, proposed definitions may be specified as “tall products have high prices”, or “tall products have low prices”, or “tall products have high heights”, etc.

With respect to definition editing, definition templates may be provided for the placeholder meanings and/or proposed definitions to a user, such as a domain expert. A definition template may represent a partial (e.g., incomplete) definition that is to be completed or otherwise verified for a term. A user, such as a domain expert, may complete or alter the definitions. For example, a definition may be edited in a structural manner (e.g., by filling out a form). Alternatively or additionally, a definition may be provided as a textual natural language definition that is interpreted in the context of an existing ontology (e.g., for definition interpretation). In this regard, any definition provided by a user may be interpreted with respect to knowledge present in an existing ontology. For example, a query may indicate “which customers bought the largest products last week”, where a definition of the term “largest” is unknown. Since “large” is an adjective that modifies “product”, the proposed definition may indicate that “large” is some type of measurement of a “product”. In this regard, the proposed definition suggested to the domain expert may indicate that “large products include high prices”. In reply, the domain expert may indicate that a large product includes a large width (or height, etc.). Thus, the domain expert may define the term with definitions that are already known in the existing ontology. Yet further, with respect to definition editing, multiple unknown terms may include interrelated definitions. For example, in the query “which customers returned products last week”, where the terms “returned” and “last week” include unknown meanings, the term “last week” may be related to (e.g., depends upon) the meaning of “returned” in the context of the particular query.

With respect to reinterpretation, the final definitions may be integrated into a domain specific ontology. The query may be interpreted using the updated domain specific ontology to provide a response as disclosed herein. Further, the updated domain specific ontology may be used to respond to other queries that include the same term including the previously unknown meaning.

The apparatuses, methods, and non-transitory computer readable media disclosed herein may be implemented in a variety of systems, such as statistical artificial intelligence based query system, symbolic artificial intelligence based query system, and other such systems that may utilize ontological information for query response.

For the apparatuses, methods, and non-transitory computer readable media disclosed herein, modules, as described herein, may be any combination of hardware and programming to implement the functionalities of the respective modules. In some examples described herein, the combinations of hardware and programming may be implemented in a number of different ways. For example, the programming for the modules may be processor executable instructions stored on a non-transitory machine-readable storage medium and the hardware for the modules may include a processing resource to execute those instructions. In these examples, a computing device implementing such modules may include the machine-readable storage medium storing the instructions and the processing resource to execute the instructions, or the machine-readable storage medium may be separately stored and accessible by the computing device and the processing resource. In some examples, some modules may be implemented in circuitry.

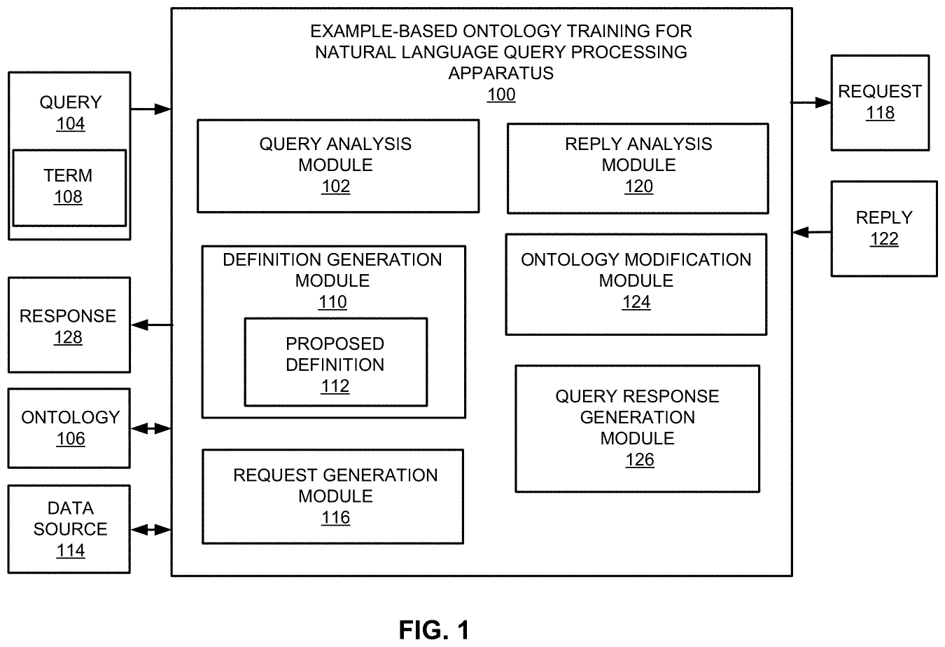

FIG. 1 illustrates a layout of an example example-based ontology training for natural language query processing apparatus (hereinafter also referred to as “apparatus 100”).

Referring to FIG. 1, the apparatus 100 may include a query analysis module 102 to identify, based on an analysis of a query 104 by using an ontology 106, a term 108 in the query 104 that includes an unknown meaning. According to examples disclosed herein, the query 104 may be specified in a natural language format.

According to examples disclosed herein, the query analysis module 102 may translate the query 104 to a computer-executable query. In this regard, the query analysis module 102 may identify, based on the analysis of the computer-executable query and the context (including but not limited to linguistic structure) of query 104 by using the ontology 106, the term 108 in the query 104 that includes the unknown meaning.

A definition generation module 110 may infer, based on a context of the query 104, a proposed definition 112 of the term 108.

According to examples disclosed herein, the definition generation module 110 may determine whether the term 108 is interpretable as a noun. Based on a determination that the term 108 is interpretable as the noun, the definition generation module 110 may infer the proposed definition 112 of the term 108 as a synonym of an object in a data source 114, a synonym of a data value in the data source 114, or a condition on the object in the data source 114.

According to examples disclosed herein, the definition generation module 110 may determine whether the term 108 is interpretable as an adjective. Based on a determination that the term 108 is interpretable as the adjective, the definition generation module 110 may determine whether the term 108 is interpretable as a superlative or whether the term is a value of an object in the data source 114. Based on a determination that the term 108 is interpretable as the superlative, the definition generation module 110 may infer the proposed definition 112 of the term 108 as being related to an object via another measurement extent object. Further, based on a determination that the term 108 is interpretable as the value of the object in the data source 114, the definition generation module 110 may infer the proposed definition 112 of the term as being related to the object in the data source 114 and an associated primary object in the data source 114.

According to examples disclosed herein, the definition generation module 110 may determine whether the term 108 is interpretable as a verb. Based on a determination that the term 108 is interpretable as the verb, the definition generation module 110 may infer the proposed definition 112 of the term 108 according to a relationship between a plurality of objects in the data source 114.

It should be noted that the determination of whether the term 108 is interpretable as a noun, as an adjective, or as a verb as disclosed above is provided for example purposes, and other examples of whether the term 108 is interpretable as a preposition, when and where, etc., are disclosed in further detail below.

According to examples disclosed herein, the definition generation module 110 may assign a placeholder meaning to the term 108. Further, the definition generation module 110 may interpret the query 104 using the placeholder meaning.

A request generation module 116 may generate, based on the proposed definition 112 of the term 108, a request 118 to provide a definition of the term 108, or to modify the proposed definition 112 of the term 108.

According to examples disclosed herein, the request generation module 116 may generate, based on the proposed definition 112 of the term 108, the request 118 to provide the definition of the term 108, approve the proposed definition 112 of the term 108, or modify the proposed definition 112 of the term 108.

A reply analysis module 120 may receive a reply 122 to the request 118. According to examples disclosed herein, the reply 122 may be in the natural language format. The reply analysis module 120 may analyze the reply 122 to update the proposed definition 112 of the term 108.

According to examples disclosed herein, the reply analysis module 120 may translate the reply 122 to a computer-executable reply. The reply analysis module 120 may analyze the computer-executable reply to update the proposed definition 112 of the term 108.

An ontology modification module 124 may modify the ontology 106 to include the updated definition of the term 108.

A query response generation module 126 may generate, based on the modified ontology, a response 128 to the query 104.

Operation of the apparatus 100 is described in further detail with reference to FIGS. 1-4.

As disclosed herein, the aforementioned operations of the apparatuses, methods, and non-transitory computer readable media disclosed herein may be implemented by performing utterance selection, unknown term inference, definition editing, and reinterpretation.

Referring to FIG. 1, with respect to unknown term inference by the apparatus 100, each unknown term (e.g., unrecognized word) in the query 104 may be treated, for purposes of syntactic and semantic interpretation, as if it were a recognized term. For example, the word “procure” may be treated as a verb with an unknown meaning in the query “Which customers procured the most cheese last week?”, even if this word does not appear in the ontology 106 for the data source 114. This placeholder may provide for completion of details in the definition of the term from the context of the query itself. In this example, the structure of the query may imply that the subject of “procure” must be a customer, and that the object of “procure” must be a product. Thus, a proposed definition derived from the utterance may be that “procure” means that “customers procure products”. This proposed definition may include a first part of a definition prompt that indicates what is being defined, and a second part of a definition text that includes the body of the proposed definition itself.

In some cases, relevant parts of a definition may not be implied in any way by the query 104, but the basic structure of the definition may be inferred. For example, in the query “How many customers bought the heaviest product?”, if the word “heaviest” is not recognized, a partial definition (and some proposed complete definitions) may be inferred. The structure of the query 104 may indicate that “heavy” is an adjective that modifies products, and that “heavy” has some associated measurement in the data source 114 indicating how heavy a product is (e.g., “heaviest” includes an “est” ending, and therefore likely corresponds to a numeric measure). By examining the structure of the data source 114 to ascertain all of the numeric measures in the PRODUCT table (e.g., price, height, and weight), some proposed definitions may be specified as follows:
Heavy products have: large prices
Heavy products have: small prices
Heavy products have: large heights
Heavy products have: small heights
Heavy products have: large weights
Heavy products have: small weights
   A user, such as a domain expert, may then select one of these proposed definitions, or may provide their own definition. Thus, a wide diversity of proposed definitions may be possible.

For example, with respect to proposed definitions, if a term with an unknown meaning can be interpreted as a noun (e.g., based on a lookup in a dictionary, or another source), the term may be defined as a synonym of an object in the data source 114 (e.g., “client is a customer”), or a synonym of a data value in the data source 114 (e.g., “USA is United States”), or a condition on an object in the data source 114 (e.g., “contractor is an employee with type=6”).

According to examples disclosed herein, if the term with an unknown meaning can be interpreted as an adjective, the adjective may be defined as a modifier of an object in the data source 114 in several different ways. For example, if the adjective is superlative, it may be related to the object via another measurement extent object. For example, for the query 104 that indicates “What is the heaviest product that John bought?”, a proposed definition may be specified as “Heavy products have: large weights”. Alternates in this regard may include small weights, large prices, and small prices.

If the adjective appears as a value of an object in the data source 114, that second object may be related to the primary object as including adjectives describing it. For example, for the query 104 that indicates “How many Chicago customers are happy?”, a proposed definition may be specified as “Happy customers have: mood=“happy” (moods describe customers)”.

For all other adjectives, the definition may likely include an explicit condition that cannot be inferred from the original query, and may need to be provided by the user (e.g., the domain expert). For example, for the query 104 that indicates “Which discontinued products are on backorder?”, a proposed definition may be specified as “Discontinued products have: [UNKNOWN],” where UNKNOWN may be provided by a domain expert as: Status=“D”.

Additional definitions may also be provided along with the original unrecognized adjective. For example, definitions may be proposed for antonyms. For example, for the query 104 that indicates “What is the heaviest product that John bought?,” a proposed definition may be specified as “For products, the opposite of heavy is: light.”

With respect to verbs, if the term that includes an unknown meaning can be interpreted as a verb, that verb may be defined as a relationship that relates two or more objects in the data source 114. For example, for the query 104 that indicates “Which customer bought the most cheese?,” a proposed definition may be specified as ““Buy” means: customers buy products”.

With respect to prepositions, if the term that includes an unknown meaning can be interpreted as a preposition, the preposition may be defined as a relationship that relates two or more objects in the data source 114. For example, for the query 104 that indicates “How many customers were in Seattle last year?,” a proposed definition may be specified as ““In” means: Customers are in cities”.

With respect to when and where, a query may refer to a location or time that modifies a known relationship in the data source 114. In this case, a when or where definition may be created. These types of definitions may identify the relationship that should be extended with a when or where. For example, for the query 104 that indicates “How much cheese was bought by John last week?”, a proposed definition may be specified as “The date/time when customers bought products is: ship date”. Alternates to this proposed definition may include order date, and packing date.

With respect to subset nouns, when a noun is not known, the syntax of the utterance and other facts in the ontology 106 may imply that it is used to indicate a subset of something else. For example, for the query 104 that indicates “Which bugs were closed last week?”, a proposed definition may be specified as “Bugs are work items that have: type=“bug””.

With respect to role nouns, if an unknown noun aligns syntactically with a role in a known relationship, a proposed definition may be specified as a term that is only used in the context of that relationship. For example, for the query 104 that indicates “Which buyer placed orders last week?”, a proposed definition may be specified as “Buyers are: customers that place orders.”

With respect to quantity and amount, queries that explicitly refer to a quantity or an amount may suggest that a quantity or an amount applies to a known relationship in the ontology 106. For example, for the query 104 that indicates “How much cheese was bought last week?”, a proposed definition may be specified as “The amount of products that are bought by customers is: net cost”. In this regard, alternates may include discount, quantity, and price.

With respect to definition interpretation by the apparatus 100, when a user, such as a domain expert, provides a definition text for the definition of a term that includes an unknown meaning in the query 104, the same natural language query interpretation may be performed on that definition text as with the original query. The resulting interpreted definition (or modification to an existing definition) may then be added to the ontology 106. In the following examples, the resulting interpreted definition may provide illustrations of the type of structured metadata that may be present in an ontology, such as the ontology 106.

For example, with respect to nouns, noun definition examples may be specified as follows.
Definition Prompt: A client is
Definition Text: a customer
Resulting definition object modification:
   Customer:
      Terms: [client]
         In this regard, the term client may be added to the ontology 106 for referring to the customer entity that is already known by the ontology 106.

Definition Prompt: United States is
Definition Text: USA
Resulting definition object modification:
   Country:
      InstanceSynonyms:
      USA: [United States]
         In this regard, the term United States may be added to the ontology 106 for referring to the USA value that is already known by the ontology 106.

Definition Prompt: A contractor is
Definition Text: an employee with type=6
Resulting new definition object:
   Employee_is_contractor:
      Subject: Employee
      Nouns: [contractor]
      Condition: Employee.Type=6
         In this regard, employee may represent a contractor relationship, where a subject of this relationship is employee, a noun defining that relationship is contractor, and the associated condition is “Employee of type=6”.

Definition Prompt: A buyer is
Definition Text: a customer that places orders
Resulting definition object modification:
   Customer_places_order:
      Subject: Customer
         Nouns: [buyer]
      Verbs: [place]
      Object: Order
         In this regard, “a customer that places orders” may be used to define the term “buyer”, and different aspects of this relationship may be added to the ontology 106.

Definition Prompt: A bug is
Definition Text: a work item with type=“bug”
Resulting new definition object:
   Customer_places_order:
      Subject: WorkItem
      Nouns: WorkItem.Type
         In this regard, “a work item with type=“bug”” may be used to define the term “bug”, and different aspects of this relationship may be added to the ontology 106.

With respect to adjectives, adjective definition examples may be specified as follows.

Definition Prompt: Heavy products have
Definition Text: higher weights
Resulting new definition object:
   Product_is_heavy:
      Subject: Product
      Adjectives: [heavy]
      Measurement: Product.Weight
         In this regard, “higher weights” may be used to define the term “heavy”, as applied to products, and different aspects of this relationship may be added to the ontology 106.

Definition Prompt: Expensive products have
Definition Text: price>10
Resulting new definition object:
   Product_is_expensive:
      Subject: Product
      Adjectives: [expensive]
      Condition: Product.Price>10
         In this regard, “price>10” may be used to define the term “expensive”, as applied to products, and different aspects of this relationship may be added to the ontology 106.

Definition Prompt: Happy customers have
Definition Text: mood=happy
Resulting new definition object:
   Customer_has_Mood:
      Subject: Customer
      Adjective: Customer.Mood
         In this regard, “mood=happy” may be used to define the terms “happy customers have”, and different aspects of this relationship may be added to the ontology 106.

With respect to antonyms, an antonym definition example may be specified as follows.

Definition Prompt: For products, the opposite of heavy is
Definition Text: light
Resulting definition object modification:
   Product_is_heavy:
      Subject: Product
      Adjectives: [heavy]
      Antonyms: [light]
      Measurement: Product.Weight
         In this regard, “light” may be used to define the antonym of heavy in the context of products, and different aspects of this relationship may be added to the ontology 106.

With respect to verbs, a verb definition example may be specified as follows.

Definition Prompt: “buy” means
Definition Text: customers buy products
Resulting new definition object:
   Customer_buys_Product:
      Subject: Customer
      Verbs: [buy]
      Object: Product
         In this regard, “customers buy products” may be used to define the term “buy”, and different aspects of this relationship may be added to the ontology 106.

A “when” definition example may be specified as follows.

Definition Prompt: The date/time when customers bought products is
Definition Text: purchase date
Resulting definition object modification:
   Customer_buys_Product:
      Subject: Customer
      Verbs: [buy]
      Object: Product
      When: Order.PurchaseDate
         In this regard, “purchase date” may be used to define a date/time in the context of customers buying products, and different aspects of this relationship may be added to the ontology 106.

A quantity definition example may be specified as follows.

Definition Prompt: The number of products that are bought by customers is
Definition Text: purchase amount
Resulting definition object modification:
   Customer_buys_Product:
      Subject: Customer
      Verbs: [buy]
      Object: Product
         Quantity: Order.NumberBought
            In this regard, “purchase amount” may be used to define quantity of products in the context of customers buying products, and different aspects of this relationship may be added to the ontology 106.

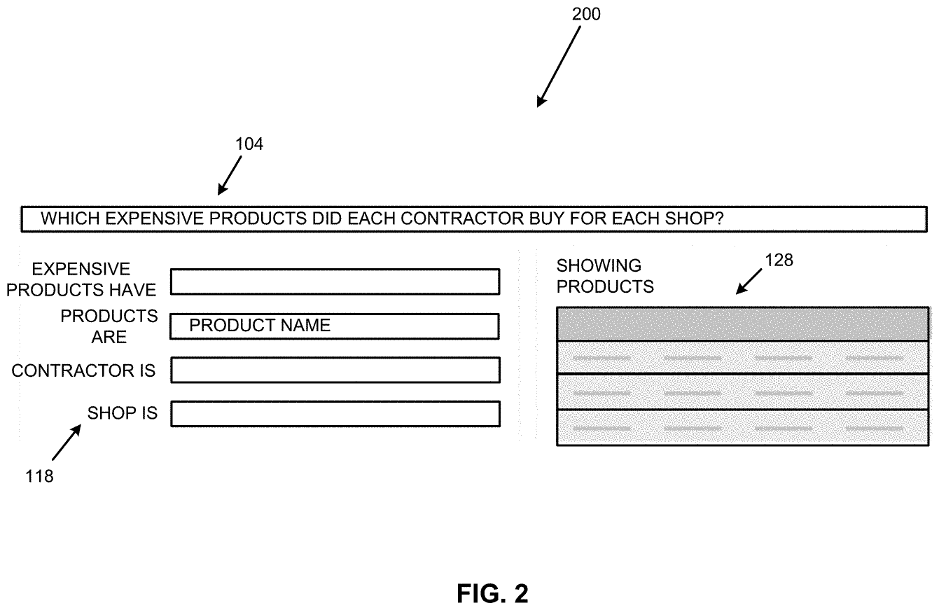

FIGS. 2-4 illustrate graphical user interface (GUI) displays to illustrate operation of the apparatus 100 in accordance with an embodiment of the present disclosure.

With respect to the example of FIGS. 2-4, a user, such as a domain expert, may enter a query 104 or select queries as disclosed herein, where the queries may include a term 108 that includes an unknown meaning. For example, the query 104 may indicate “Which expensive products did each contractor buy for each shop?”. This query may include several terms that include unknown meanings. For example, the terms “expensive”, “contractor”, and “shop” may include unknown meanings, and for the term “products”, the query analysis module 102 may determine a possibly correct meaning.

Referring to FIG. 2, for the query 104, a display 200 is shown and may include the response 128 that shows a list of all products. Alongside the response 128 that includes a list of all products, a list of definition prompts may be presented for each of the terms that include unknown meanings, or for which there is uncertainty as to the meaning. Requests, such as the request 118, may be presented for completion of the definition of such terms.

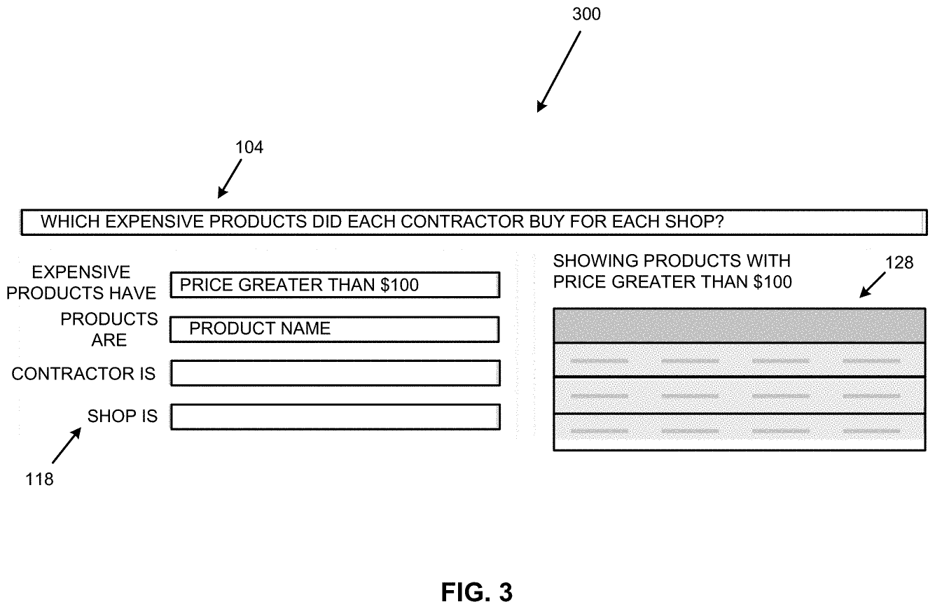

Referring to FIG. 3, assuming that the definition (e.g., reply 122) that is entered for the request 118 that specifies “Expensive products have” is “Price greater than $100”, this information may be added to the ontology 106 to thus allow the term “expensive” to be recognized, thereby bringing the response 128 closer to the desired result. For example, for the display 300, the response 128 may include products with a price greater than $100.

Each request 118 may thus be completed, and the response 128 may be updated in a corresponding manner.

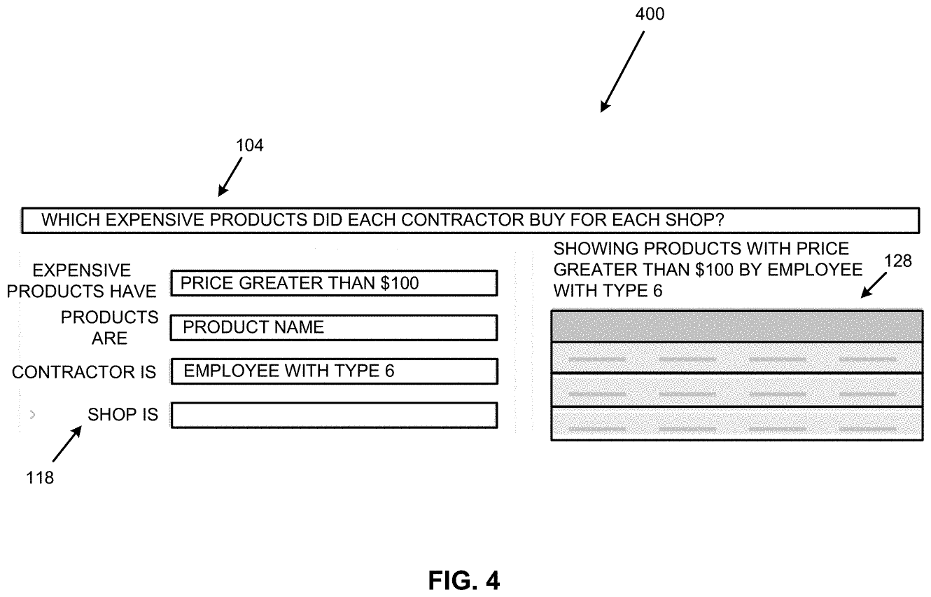

Referring to FIG. 4, for the display 400, with all of the definitions (e.g., replies) being entered as shown, the response 128 may include “products with price greater than $100 by employee with type 6.”

The updated ontology 106 may be used for understanding all future queries that include the terms with the unknown meanings (or possibly correct meanings) specified in the query 104 of FIGS. 2-4.

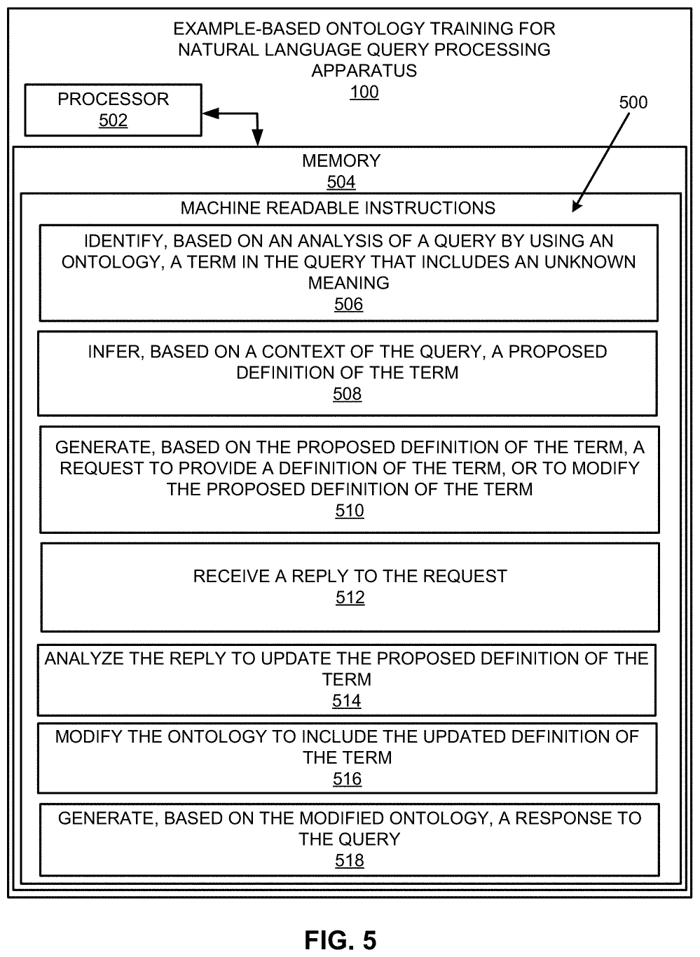

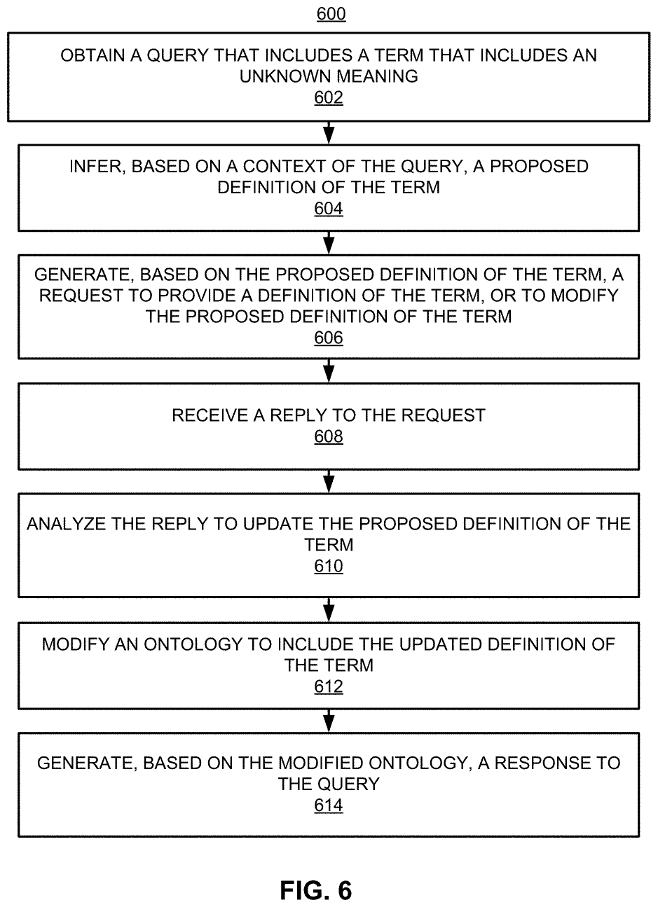

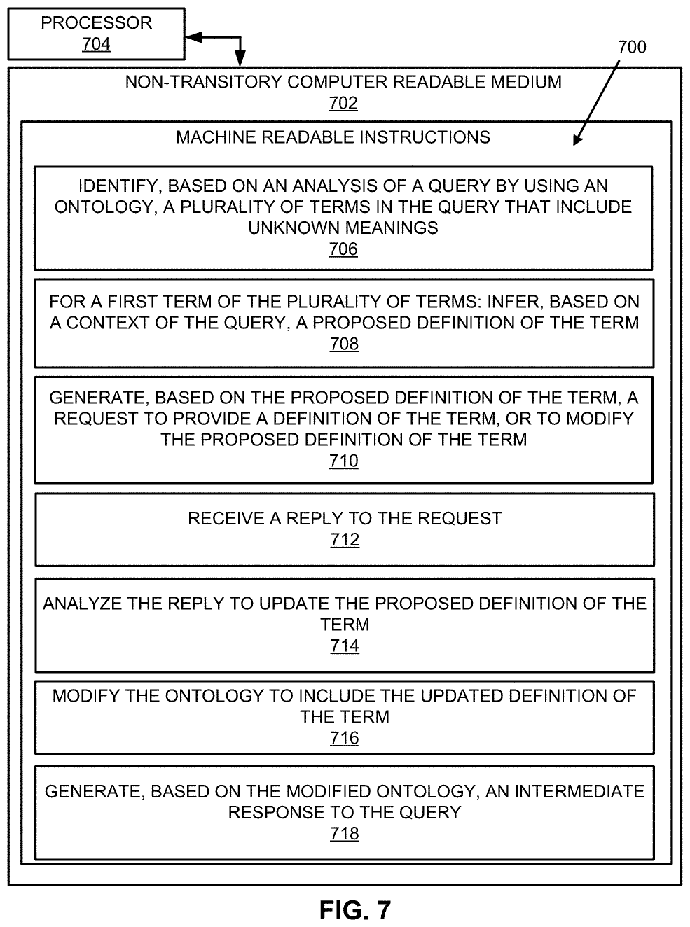

FIGS. 5-7 respectively illustrate an example block diagram 500, a flowchart of an example method 600, and a further example block diagram 700 for example-based ontology training for natural language query processing, according to examples. The block diagram 500, the method 600, and the block diagram 700 may be implemented on the apparatus 100 described above with reference to FIG. 1 by way of example and not of limitation. The block diagram 500, the method 600, and the block diagram 700 may be practiced in other apparatus. In addition to showing the block diagram 500, FIG. 5 shows hardware of the apparatus 100 that may execute the instructions of the block diagram 500. The hardware may include a processor 502, and a memory 504 storing machine readable instructions that when executed by the processor cause the processor to perform the instructions of the block diagram 500. The memory 504 may represent a non-transitory computer readable medium. FIG. 6 may represent an example method for example-based ontology training for natural language query processing, and the steps of the method. FIG. 7 may represent a non-transitory computer readable medium 702 having stored thereon machine readable instructions to provide example-based ontology training for natural language query processing according to an example. The machine readable instructions, when executed, cause a processor 704 to perform the instructions of the block diagram 700 also shown in FIG. 7.

The processor 502 of FIG. 5 and/or the processor 704 of FIG. 7 may include a single or multiple processors or other hardware processing circuit, to execute the methods, functions and other processes described herein. These methods, functions and other processes may be embodied as machine readable instructions stored on a computer readable medium, which may be non-transitory (e.g., the non-transitory computer readable medium 702 of FIG. 7), such as hardware storage devices (e.g., RAM (random access memory), ROM (read only memory), EPROM (erasable, programmable ROM), EEPROM (electrically erasable, programmable ROM), hard drives, and flash memory). The memory 504 may include a RAM, where the machine readable instructions and data for a processor may reside during runtime.

Referring to FIGS. 1-5, and particularly to the block diagram 500 shown in FIG. 5, the memory 504 may include instructions 506 to identify, based on an analysis of a query 104 by using an ontology 106, a term 108 in the query 104 that includes an unknown meaning.

The processor 502 may fetch, decode, and execute the instructions 508 to infer, based on a context of the query 104, a proposed definition 112 of the term 108.

The processor 502 may fetch, decode, and execute the instructions 510 to generate, based on the proposed definition 112 of the term 108, a request 118 to provide a definition of the term 108, or to modify the proposed definition 112 of the term 108.

The processor 502 may fetch, decode, and execute the instructions 512 to receive a reply 122 to the request 118.

The processor 502 may fetch, decode, and execute the instructions 514 to analyze the reply 122 to update the proposed definition 112 of the term 108.

The processor 502 may fetch, decode, and execute the instructions 516 to modify the ontology 106 to include the updated definition of the term 108.

The processor 502 may fetch, decode, and execute the instructions 518 to generate, based on the modified ontology, a response 128 to the query 104.

Referring to FIGS. 1-4 and 6, and particularly FIG. 6, for the method 600, at block 602, the method may include obtaining a query 104 that includes a term 108 that includes an unknown meaning.

At block 604, the method may include inferring, based on a context of the query 104, a proposed definition 112 of the term 108.

At block 606, the method may include generating, based on the proposed definition 112 of the term 108, a request 118 to provide a definition of the term 108, or to modify the proposed definition 112 of the term 108.

At block 608, the method may include receiving a reply 122 to the request 118.

At block 610, the method may include analyzing the reply 122 to update the proposed definition 112 of the term 108.

At block 612, the method may include modifying an ontology 106 to include the updated definition of the term 108.

At block 614, the method may include generating, based on the modified ontology 106, a response to the query 104.

Referring to FIGS. 1-4 and 7, and particularly FIG. 7, for the block diagram 700, the non-transitory computer readable medium 702 may include instructions 706 to identify, based on an analysis of a query 104 by using an ontology 106, a plurality of terms in the query 104 that include unknown meanings.

The processor 704 may fetch, decode, and execute the instructions 708 to, for a first term of the plurality of terms, infer, based on a context of the query 104, a proposed definition of the term 108.

The processor 704 may fetch, decode, and execute the instructions 710 to generate, based on the proposed definition 112 of the term 108, a request 118 to provide a definition of the term 108, or to modify the proposed definition 112 of the term 108.

The processor 704 may fetch, decode, and execute the instructions 712 to receive a reply 122 to the request 118.

The processor 704 may fetch, decode, and execute the instructions 714 to analyze the reply 122 to update the proposed definition 112 of the term 108.

The processor 704 may fetch, decode, and execute the instructions 716 to modify the ontology 106 to include the updated definition of the term 108.

The processor 704 may fetch, decode, and execute the instructions 718 to generate, based on the modified ontology, an intermediate response to the query 104.

With respect to the steps 708-718 discussed above, according to examples disclosed herein, step 708 may be performed on all terms, then step 710 may be performed on all terms, and thereafter steps 712-718 may be performed in sequence for each term as a domain expert provides, accepts, and/or modifies each proposed definition.

According to examples disclosed herein, for another term of the plurality of terms, the processor 704 may fetch, decode, and execute the instructions to infer, based on the context of the query 104, another proposed definition of the another term. The processor 704 may fetch, decode, and execute the instructions to generate, based on the another proposed definition of the another term, another request to provide the definition of the another term, or to modify the another proposed definition of the another term. The processor 704 may fetch, decode, and execute the instructions to receive the reply 122 to the another request. The processor 704 may fetch, decode, and execute the instructions to analyze the reply 122 to the another request to update the another proposed definition of the another term. The processor 704 may fetch, decode, and execute the instructions to further modify the ontology 106 to include the updated definition of the another term. The processor 704 may fetch, decode, and execute the instructions to generate, based on the further modified ontology 106, a response 128 to the query 104. For remaining terms of the plurality of terms, the processor 704 may fetch, decode, and execute the instructions to modify the ontology 106 to include updated definitions of the remaining terms. Further, the processor 704 may fetch, decode, and execute the instructions to generate, based on the modified ontology 106 that includes updated definitions of the remaining terms, further responses to the query 104.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. An apparatus comprising:
a processor; and
a memory storing machine readable instructions that when executed by the processor cause the processor to:
identify, based on an analysis of a query by using an ontology, a term in the query that includes an unknown meaning, wherein the query is in a natural language format;
infer, based on a context of the query, a proposed definition of the term;
generate, based on the proposed definition of the term, a request to provide a definition of the term, or to modify the proposed definition of the term;
receive a reply to the request, wherein the reply is in the natural language format;
analyze the reply to update the proposed definition of the term;
modify the ontology to include the updated definition of the term; and
generate, based on the modified ontology, a response to the query.

2. The apparatus according to claim 1, wherein the instructions to identify, based on the analysis of the query by using the ontology, the term in the query that includes the unknown meaning are further to cause the processor to:
translate the query to a computer-executable query; and
identify, based on the analysis of the computer-executable query by using the ontology, the term in the query that includes the unknown meaning.

3. The apparatus according to claim 1, wherein the instructions to analyze the reply to update the proposed definition of the term are further to cause the processor to:
translate the reply to a computer-executable reply; and
analyze the computer-executable reply to update the proposed definition of the term.

4. The apparatus according to claim 1, wherein the instructions to generate, based on the proposed definition of the term, the request to provide the definition of the term, or to modify the proposed definition of the term are further to cause the processor to:
generate, based on the proposed definition of the term, the request to provide the definition of the term, approve the proposed definition of the term, or modify the proposed definition of the term.

5. The apparatus according to claim 1, wherein the instructions to infer, based on the context of the query, the proposed definition of the term are further to cause the processor to:
assign a placeholder meaning to the term;
interpret the query using the placeholder meaning; and
infer, based on the context of the query and the placeholder meaning assigned to the term, the proposed definition of the term.

6. The apparatus according to claim 1, wherein the instructions are further to cause the processor to:
determine whether the term is interpretable as a noun; and
based on a determination that the term is interpretable as the noun, infer the proposed definition of the term as a synonym of an object in a data source, a synonym of a data value in the data source, or a condition on the object in the data source.

7. The apparatus according to claim 1, wherein the instructions are further to cause the processor to:
determine whether the term is interpretable as an adjective;
based on a determination that the term is interpretable as the adjective, determine whether the term is interpretable as a superlative or whether the term is a value of an object in a data source;
based on a determination that the term is interpretable as the superlative, infer the proposed definition of the term as being related to an object via another measurement extent object; and
based on a determination that the term is interpretable as the value of the object in the data source, infer the proposed definition of the term as being related to the object in the data source and an associated primary object in the data source.

8. The apparatus according to claim 1, wherein the instructions are further to cause the processor to:
determine whether the term is interpretable as a verb; and
based on a determination that the term is interpretable as the verb, infer the proposed definition of the term according to a relationship between a plurality of objects in a data source.

9. A computer-implemented method comprising:
obtaining a query that includes a term that includes an unknown meaning, wherein the query is in a natural language format;
inferring, based on a context of the query, a proposed definition of the term;
generating, based on the proposed definition of the term, a request to provide a definition of the term, or to modify the proposed definition of the term;
receiving a reply to the request, wherein the reply is in the natural language format;
analyzing the reply to update the proposed definition of the term;
modifying an ontology to include the updated definition of the term; and
generating, based on the modified ontology, a response to the query.

10. The computer-implemented method according to claim 9, wherein obtaining the query that includes the term that includes the unknown meaning further comprises:
selecting, from a plurality of queries, the query that includes the term that represents a frequently used term that includes the unknown meaning.

11. The computer-implemented method according to claim 9, wherein analyzing the reply to update the proposed definition of the term further comprises:
translating the reply to a computer-executable reply; and
analyzing the computer-executable reply to update the proposed definition of the term.

12. The computer-implemented method according to claim 9, wherein generating, based on the proposed definition of the term, the request to provide the definition of the term, or to modify the proposed definition of the term further comprises:
generating, based on the proposed definition of the term, the request to provide the definition of the term, approve the proposed definition of the term, or modify the proposed definition of the term.

13. The computer-implemented method according to claim 9, wherein inferring, based on the context of the query, the proposed definition of the term further comprises:
assigning a placeholder meaning to the term;
interpreting the query using the placeholder meaning; and
inferring, based on the context of the query and the placeholder meaning assigned to the term, the proposed definition of the term.

14. A non-transitory computer readable medium having stored thereon machine readable instructions, the machine readable instructions, when executed by a processor, cause the processor to:
identify, based on an analysis of a query by using an ontology, a plurality of terms in the query that include unknown meanings, wherein the query is in a natural language format; and
for a first term of the plurality of terms:
infer, based on a context of the query, a proposed definition of the term;
generate, based on the proposed definition of the term, a request to provide a definition of the term, or to modify the proposed definition of the term;
receive a reply to the request;
analyze the reply to update the proposed definition of the term;
modify the ontology to include the updated definition of the term; and
generate, based on the modified ontology, an intermediate response to the query.

15. The non-transitory computer readable medium according to claim 14, wherein the instructions are further to cause the processor to:
for another term of the plurality of terms:
infer, based on the context of the query, another proposed definition of the another term;
generate, based on the another proposed definition of the another term, another request to provide the definition of the another term, or to modify the another proposed definition of the another term;
receive the reply to the another request;
analyze the reply to the another request to update the another proposed definition of the another term;
further modify the ontology to include the updated definition of the another term; and
generate, based on the further modified ontology, a response to the query.

16. The non-transitory computer readable medium according to claim 14, wherein the instructions are further to cause the processor to:
determine whether the term is interpretable as a noun; and
based on a determination that the term is interpretable as the noun, infer the proposed definition of the term as a synonym of an object in a data source, a synonym of a data value in the data source, or a condition on the object in the data source.

17. The non-transitory computer readable medium according to claim 14, wherein the instructions to identify, based on the analysis of the query by using the ontology, the plurality of terms in the query that include unknown meanings are further to cause the processor to:
translate the query to a computer-executable query; and
identify, based on the analysis of the computer-executable query by using the ontology, the plurality of terms in the query that include unknown meanings.

18. The non-transitory computer readable medium according to claim 14, wherein the instructions to analyze the reply to update the proposed definition of the term are further to cause the processor to:
translate the reply to a computer-executable reply; and
analyze the computer-executable reply to update the proposed definition of the term.

19. The non-transitory computer readable medium according to claim 14, wherein the instructions to generate, based on the proposed definition of the term, the request to provide the definition of the term, or to modify the proposed definition of the term are further to cause the processor to:
generate, based on the proposed definition of the term, the request to provide the definition of the term, approve the proposed definition of the term, or modify the proposed definition of the term.

20. The non-transitory computer readable medium according to claim 14, wherein the instructions to infer, based on the context of the query, the proposed definition of the term are further to cause the processor to:
assign a placeholder meaning to the term;
interpret the query using the placeholder meaning; and
infer, based on the context of the query and the placeholder meaning assigned to the term, the proposed definition of the term.
